(19) United States
(12) Patent Application Publication
(10) Pub. No.: US 2015/0364972 A1
(43) Pub. Date: Dec. 17, 2015

(54) ANGLE TOOL AND ELECTRIC TOOL

(71) Applicant: MAKITA CORPORATION, Anjo-shi, Aichi (JP)

(72) Inventor: Yoshihiro ITO, Anjo-shi (JP)

(73) Assignee: MAKITA CORPORATION, Anjo-shi, Aichi (JP)

(21) Appl. No.: 14/763,626

(22) PCT Filed: Feb. 5, 2014
(86) PCT No.: PCT/JP2014/052678

§ 371 Date: Jul. 27, 2015

(30) Foreign Application Priority Data
Apr. 4, 2013 (JP) 2013-078810

(51) Int. Cl. H02K 7/14; H02K 11/00; H02K 5/04

(52) U.S. Cl. CPC H02K 7/145; H02K 5/04; H02K 11/0068; H02K 11/0015

(57) ABSTRACT

An angle impact driver includes a brushless motor having a motor shaft, a switch for energizing the brushless motor, an output shaft to which rotation of the brushless motor is transferred, the output shaft being angled with respect to the motor shaft, a housing accommodating the brushless motor and the switch, and a the sensor board detecting rotation of the motor shaft, in which the sensor board is secured to the brushless motor.

### BACKGROUND OF THE INVENTION

1. Technical Field

The present invention relates to an angle tool having an output shaft angled with respect to a motor shaft and an electric tool having the output shaft.

2. Background Art

As described in Japanese Patent Application Publication No. 2009-90434 below, there is a known electric drill in which a bit rotates about an axis intersecting the rotation axis of a motor.

Since the motor of the electric drill rotates the rotating part by switching the direction of electric current flowing through the coil of the rotating part, the motor has a commutator that can make contact with the brush of the stationary part on the rotary shaft side.

This brush gradually wears due to contact with the rotating commutator, and therefore, the brush does not sufficiently conduct electricity eventually, and reaches the end of its life. Accordingly, the electric drill is provided with a projection or lid for replacing the brush.

### SUMMARY OF INVENTION

As the conventional electric drill described above has a commutator and brush for rotating a rotary shaft of the motor, a projection or lid for replacing the brush is necessary, and therefore the compactness is compromised. In addition, depending on the arrangement of the projection or lid, the operability is slightly lost because it becomes difficult to grip the electric drill during operation.

If the brush reaches the end of the life, the motor does not rotate and the bit cannot rotate, and the electric drill becomes unavailable until a new brush is substituted. In addition, the replacing of the brush takes time and effort.

A main object of the invention is to provide an angle tool that is more compact and easy to grasp, reduces time and effort of maintenance, and reduces an unavailable period.

To achieve the above object, in a first aspect of the invention, an angle tool includes a brushless motor having a motor shaft, a switch for energizing the brushless motor, an output shaft to which rotation of the brushless motor is transferred, the output shaft being angled with respect to the motor shaft, a housing accommodating the brushless motor and the switch, and a control circuit board accommodated in the housing, in which the switch is disposed between the control circuit board and the brushless motor.

In a second aspect of the invention, according to the first aspect, the angle tool further includes a sensor board detecting rotation of the motor shaft, in which the sensor board is secured to the brushless motor.

In a third aspect of the invention, according to the first aspect, the angle tool further includes a battery, in which the battery is secured to the housing, and the switch is disposed between the battery and the brushless motor.

In a fourth aspect of the invention, according to the first aspect, the angle tool further includes a rotor having the motor shaft, a sensor board detecting rotation of the rotor, and a stator, in which the brushless motor includes the rotor and the stator, and the stator is disposed between the sensor board and the switch.

In a fifth aspect of the present invention, according to the first aspect, the angle tool further includes a rotor having the motor shaft, a fan secured to the motor shaft, and a stator, in which the brushless motor includes the rotor and the stator, and the stator is disposed between the fan and the switch.

In a sixth aspect of the present invention, according to the first aspect, the angle tool further includes a rotor having the motor shaft, a fan secured to the motor shaft, a stator, and a plurality of switching elements electrically connected to the stator, in which the brushless motor includes the rotor and the stator, and the switch is provided between the control circuit board and the plurality of switching elements.

In a seventh aspect of the invention, an electric tool includes a brushless motor having a stator and a rotor, a motor shaft secured to the rotor, a fan secured to the motor shaft, a switch for energizing the brushless motor, an output shaft to which rotation of the brushless motor is transferred, and a housing accommodating the brushless motor and the switch, in which the switch, the brushless motor, and the output shaft are disposed in a single straight line.

According to the first aspect of the invention, the switch is disposed between the control circuit board and the brushless motor. Accordingly, wiring is easily performed, heat resistance is further improved, and the operation of a brushless motor becomes more reliable. Further, a more compact and easy-to-grasp structure is achieved, and time and effort of maintenance are reduced, thereby reducing an unavailable period.

According to the second aspect of the invention, the sensor board is secured to the brushless motor. Accordingly, the rotation state of the motor shaft can be detected reliably in an efficient structure, a more compact and easy-to-grasp structure is achieved, and time and effort of maintenance are reduced, thereby reducing an unavailable period.

According to the third aspect of the invention, the switch is disposed between the battery and the brushless motor. Accordingly, wiring can be routed easily, and a wire break does not easily occur even if a load is applied. Further, a more compact and easy-to-grasp structure is achieved, and time and effort of maintenance are reduced, thereby reducing an unavailable period.

According to the fourth aspect of the invention, the stator of the brushless motor is disposed between the sensor board and the switch. Accordingly, an air flow becomes smoother, a more compact and easy-to-grasp structure is achieved, and time and effort of maintenance are reduced, thereby reducing an unavailable period.

According to the fifth aspect of the invention, the stator of the brushless motor is disposed between the fan and the switch. Accordingly, the cooling efficiency of the brushless motor is improved, a more compact and easy-to-grasp structure is achieved, and time and effort of maintenance are reduced, thereby reducing an unavailable period.

According to the sixth aspect of the invention, the switch is disposed between the control circuit board and the switching elements. Accordingly, the switching element and control circuit board can be easily cooled, and more reliable operation is ensured. Further, a more compact and easy-to-grasp structure is achieved, and time and effort of maintenance are reduced, thereby reducing an unavailable period.

According to the seventh aspect of the invention, the switch, the brushless motor, and the output shaft are disposed in a single straight line. Accordingly, a more compact and easy-to-grasp structure is achieved, and time and effort of maintenance are reduced, thereby reducing an unavailable period.

### BRIEF DESCRIPTION OF DRAWINGS

FIG. 1 is a vertical central cross-sectional view showing an angle impact driver according to a first embodiment of the present invention.

FIG. 2 is an enlarged view of the front part in FIG. 1.

FIG. 3 is a cross-sectional view showing a cross-section A-A in FIG. 1.

FIG. 4 is a circuit diagram including the control circuit board in FIG. 3.

FIG. 5 is a diagram equivalent to FIG. 1 according to a second embodiment of the invention.

FIG. 6 is an enlarged view of the front part in FIG. 5.

FIG. 7 is a cross-sectional view showing a cross-section B-B in FIG. 5.

FIG. 8 is a diagram equivalent to FIG. 1 according to a third embodiment of the invention.

FIG. 9 is an enlarged view of the front part in FIG. 8.

FIG. 10 is a cross-sectional view showing a cross-section C-C in FIG. 8 (FIG. 9).

FIG. 11 is a diagram equivalent to FIG. 4 according to the third embodiment.

FIG. 12 is a diagram equivalent to FIG. 1 according to a fourth embodiment.

FIG. 13 is an enlarged view of the front part in FIG. 12.

FIG. 14 is a cross-sectional view showing a cross-section D-D in FIG. 12 (FIG. 13).

### DESCRIPTION OF EMBODIMENTS

Embodiments of the present invention and modifications will be described with reference to the drawings as appropriate.

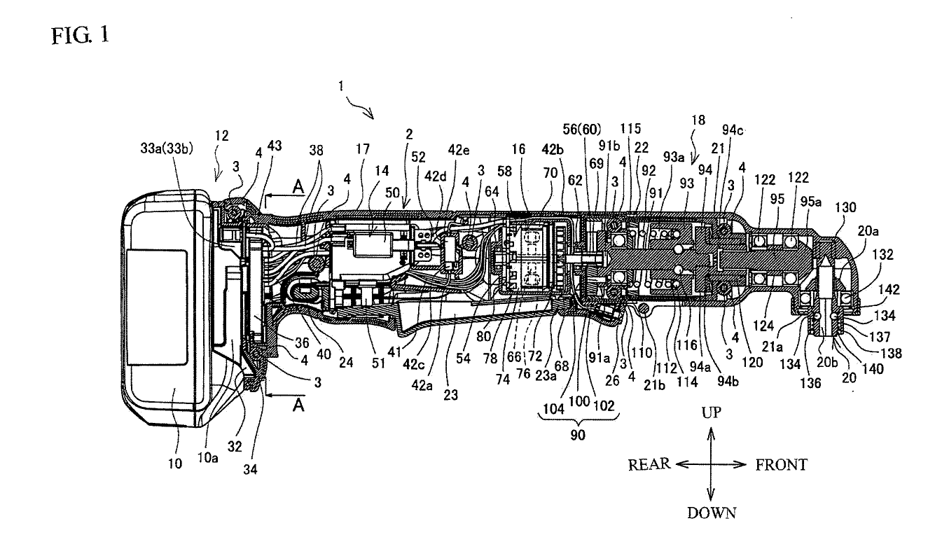

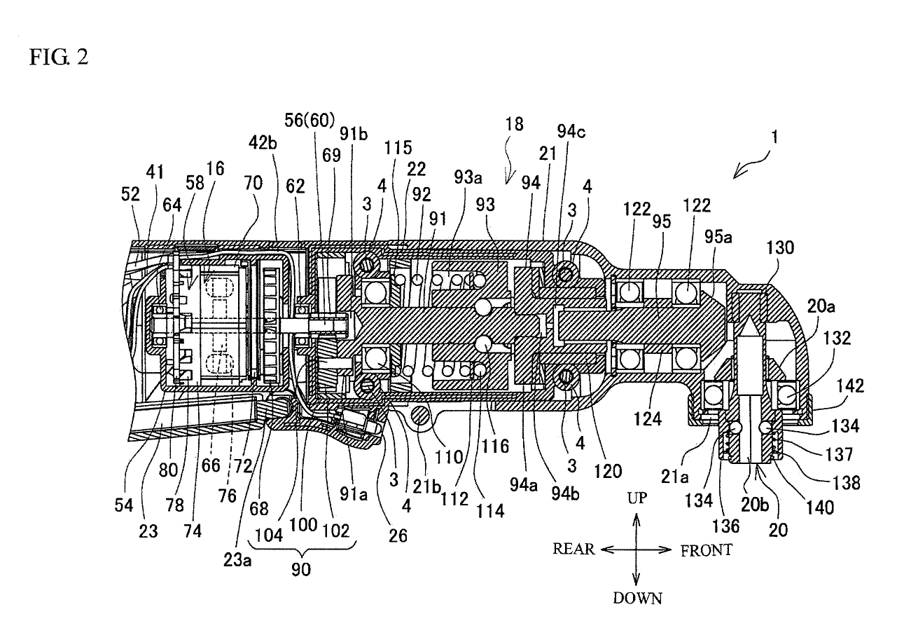

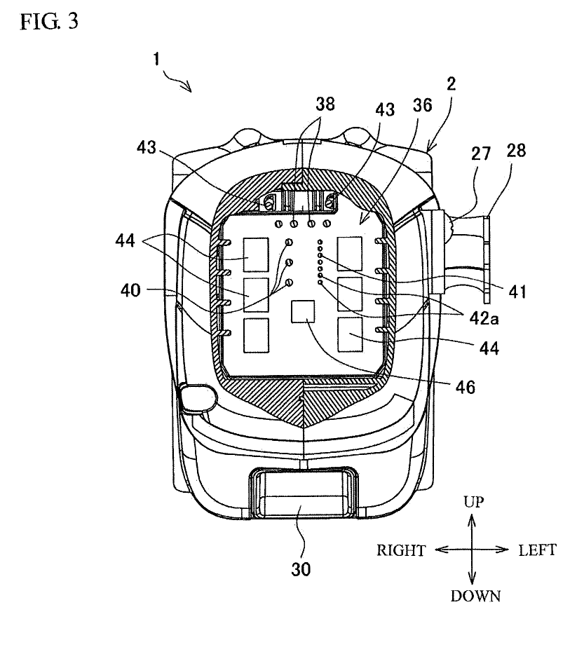

FIG. 1 is a vertical central cross-sectional view showing an angle impact driver 1, which is an example of an angle type electric tool, according to a first embodiment. FIG. 2 is an enlarged view of the front part in FIG. 1. FIG. 3 is a cross-sectional view showing a cross-section A-A in FIG. 1. The angle type means that a shaft of a motor intersects the output shaft at substantially 90 degrees. The right in FIG. 1 indicates the front in the angle impact driver 1.

The angle impact driver 1 has a housing 2 forming its outer shell. The housing 2 is formed so as to be halved into the left half and right half, which are coupled by a plurality of screws 3, 3 . . . and their corresponding cylindrical screw holes 4, 4 . . . .

The housing 2 is formed like a cylinder having a center axis extending the front-rear direction.

In the rear end part of the housing 2, there is a battery attachment portion 12 to which a battery 10 can be attached.

In the rear part of the housing 2, a switch 14 is accommodated in front of the battery attachment portion 12.

In the middle part of the housing 2, a brushless motor 16 is accommodated in front of the switch 14. In the housing 2, the part from the battery attachment portion 12 to the outside of the front of the brushless motor 16 is a main body housing 17. The main body of the angle impact driver 1 is formed by the main body housing 17 or members accommodated in the main body housing 17.

In the front part of the housing 2, a driving force transfer mechanism 18 and an output shaft 20 are accommodated in front of the brushless motor 16. In the housing 2, the parts covering the driving force transfer mechanism 18 and the output shaft 20 are a metal hammer case 21 and a gear case 22 disposed in the front part of the main body housing 12. The hammer case 21 is secured to the gear case 22 by a set screw 21b. A hammer 93 and an anvil 94, which will be described later, are covered with the hammer case 21 and the gear case 22 doubly.

On the lower side of the switch 14, there is a trigger type switch lever 23, which can be pressed by the user's finger or the like, so as to be partly exposed from the housing 2. At the rear of the switch lever 23, a forward-reverse inverting switch 24 is accommodated so as to be partly exposed from the left side and the right side of the housing 2. The forward-reverse inverting switch 24 sequentially switches the rotation direction of the brushless motor 16. The switch lever 23 is configured so as to be pivotable about an upper end 23a.

In the rear part or the middle part of the housing 2, an outer part, which is located between the forward-reverse inverting switch 24 and the outside of the brushless motor 16, is formed as a grip grasped by the user. A stopper member (thermoplastic elastomer) is provided on the grip.

A light (LED) 26 for illuminating the front (the vicinity of the lower end of the output shaft 20) is provided in the lower front of the brushless motor 16.

A hook 28 is attached by a screw 27 on the side of the rear part of the housing 2 (FIG. 3). The battery 10 is a substantially rectangular parallelepiped rechargeable battery incorporating lithium ion battery cells.

The battery 10 has a removal button 30 that can be pushed forward in the rear lower part (FIG. 3). The removal button 30 is biased backward by an elastic body (spring) and normally positioned along other components of the battery 10. In addition, in the lower front part, the battery 10 has a claw 32 that can eject or retract with respect to the surrounding. When the removal button 30 is located in a normal position, the claw 32 ejects. When the removal button 30 is pushed forward against a biasing force, the claw 32 is embedded. The battery 10 has a terminal 33a on the front surface and two rails 10a and 10a extending upward and downward.

The battery attachment portion 12 has a planar portion extending upward, downward, leftward, and rightward. An engaging concave portion 34 recessed forward with respect to the surrounding is formed on the lower side of the planar portion. The battery attachment portion 12 has a rail engaging portion engaging a corresponding rail 10a of the battery 10 as well as a terminal 33b.

When the battery 10 is slid upward from below while the rail 10a of the battery 10 is aligned with the rail engaging portion with respect to the battery attachment portion 12, the claw 32 engages the concave portion 34 and the battery 10 is attached. At this time, the terminal 33a of the battery 10 engages and makes contact with the corresponding terminal 33b of the battery attachment portion 12.

As shown mainly in FIG. 3, on the inner side (front side) of the battery attachment portion 12, the control circuit board 36 is disposed.

Power lead wires 38 and 38 are installed between the control circuit board 36 and the switch 14 provided in front of the control circuit board 36. In addition, lead wires 40, 40 . . . for rotation control and lead wires 41, 41 . . . for rotation detection signals are installed between the control circuit board 36 and a sensor board 80, which will be described later, secured to the brushless motor 16 in front of the control circuit board 36. In addition, lead wires 42a and 42b are installed between the control circuit board 36 and the light 26 in front of the control circuit board 36. Connector 42c and 42d that can be coupled to each other are provided between the lead wires 42a and 42b. In a rib 42e of the housing 2, the connectors 42c and 42d are attached in a state in which they are coupled to each other. The middle part of the lead wire 42b for the light is disposed above or in front of the outside of a motor housing 54, which will be described later. Power lead wires 43 and 43 are installed between the control circuit board 36 and the terminal 33b of the battery attachment portion 12. Electricity at the terminal 33b of the battery attachment portion 12 is conducted to the switch 14 through the power lead wires 43 and 43, the control circuit board 36, and the power lead wires 38 and 38.

In addition, a plurality of (six) switching elements 44, 44 . . . and a microcomputer 46 are mounted on the control circuit board 36.

The three switching elements 44, 44 . . . are arranged vertically in the left and right rows. The three switching elements 44, 44 . . . are disposed on each of the left and right sides of the microcomputer 46.

The switch 14 switches an energization state of the brushless motor 16 and energizes the brushless motor 16.

The switch 14 includes a switch body 50 and a plunger 51 projecting downward from a bottom of the switch body 50. When the plunger 51 is pressed upward, the switch 14 is turned on. When the plunger 51 is not pressed and placed in the normal position, the switch 14 is turned off. The lower part of the plunger 51 is in contact with the rear part of the switch lever 23.

Power lead wires 52 and 52 are installed between the switch 14 and the sensor board 80, which will be described later, secured to the brushless motor 16 provided in front of the switch 14.

The brushless motor 16 includes a rotor 56, which is a rotating part, and a stator 58, which is a stationary part. The brushless motor 16 is accommodated in the motor housing 54.

The rotor 56 includes a motor shaft 60, which is a rotary shaft of the brushless motor 16, a front bearing 62 pivotally supporting the front part of the motor shaft 60, a rear bearing 64 pivotally supporting the rear end part of the motor shaft 60, a rotor core (rotating part iron core) provided integrally with the motor shaft 60 at the middle part of the motor shaft 60, and a magnet 66. On the rear side of the front bearing 62, a fan 68 for exhausting dust and heat is provided integrally with the motor shaft 60. In the front end part of the motor shaft 60, a pinion 69 is secured.

The front bearing 62 is held at the rear middle of the gear case 22 and the rear bearing 64 is held in the middle in the rear end part of the motor housing 54.

The stator 58 includes a cylindrical stationary part iron core 70 having an axis in front-back direction, a disc-shaped first insulating member 72 disposed on the front side of the stator core (stationary part iron core) 70, a disc-shaped second insulating member 74 disposed at the rear of the stator core 70 or in the stator core 70, and a plurality of (six in this case) coils 76, 76 . . . wound around the stator core 70 via the first insulating member 72 and the second insulating member 74.

In addition, on the rear surface of the second insulating member 74, a plurality of concave portions 78, 78 . . . recess forward with respect to the other part of the rear surface and extend radially.

The disc-shaped sensor board 80 is placed on the rear side of the second insulating member 74.

The sensor board 80 is disposed so that the part of the rear surface of the second insulating member 74 excluding the concave portions 78 makes contact with a corresponding part of the substantially flat front surface of the sensor board 80. The concave portions 78 form a space between the second insulating member 74 and the sensor board 80. The upper end part of the sensor board 80 projects through a hole created in the upper rear part of the motor housing 54, and the lead wires 40 and 41 and the power lead wire 52 are connected to the upper end part. In addition, a hole through which the motor shaft 60 passes is bored in the center of sensor board 80.

An intake port (not shown) is formed in the main body housing 17 outside the switch 14. The outside air introduced by the fan 68 from the intake port to the housing 2 can flow into the brushless motor 16 via the space between the second insulating member 74 and the sensor board 80. An exhaust port (not shown) is formed in the main body housing 17 outside the fan 68.

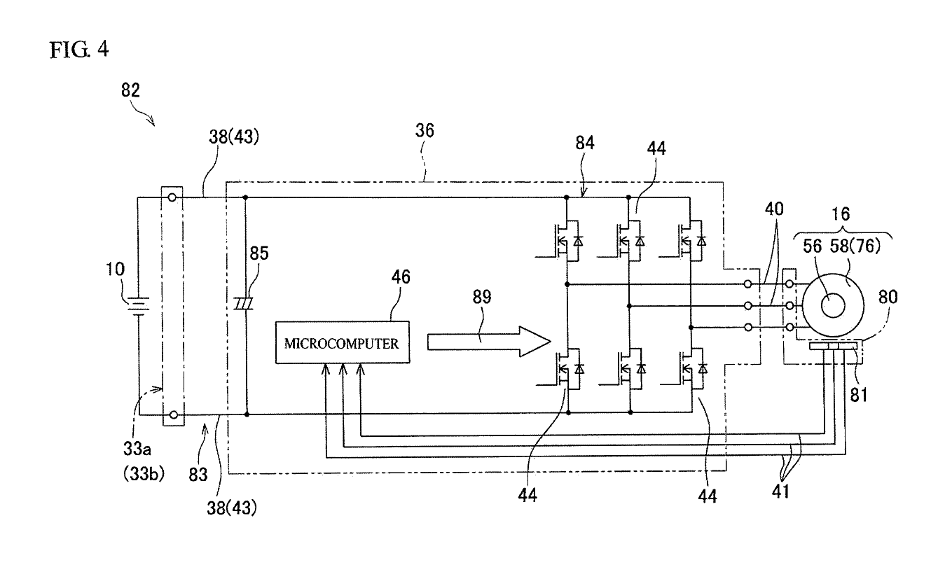

The sensor board 80 has a plurality of (three in this case) rotation detection elements 81, 81 . . . as rotation detection sensors (see FIG. 4).

The rotation detection elements 81, 81 . . . are disposed at regular intervals in the upper part of the front surface of the sensor board 80.

FIG. 4 shows a driving circuit 82 of the angle impact driver 1 including the switching elements 44 and the rotation detection elements 81.

The driving circuit 82 includes a power supply circuit portion 83, a three-phase bridge circuit portion 84 including the switching elements 44, 44 . . . , and the microcomputer 46 controlling the switching elements 44, 44 . . . and so on.

The power supply circuit portion 83 is mainly disposed on the control circuit board 36 and suppresses voltage fluctuations of electric power supplied from the battery 10 via the terminals 33a and 33b. The power supply circuit portion 83 includes the power lead wires 38, 43 . . . and a power smoothing capacitor 85 connected in parallel with the power lead wires 38, 43 . . . .

The three-phase bridge circuit portion 84 is disposed on the control circuit board 36, is connected to the power lead wires 38, 43 . . . in parallel with the power smoothing capacitor 85, and has three output wires running from three pairs of switching elements 44 and 44. The three output wires are connected to the corresponding coils 76 in the stator 58 of the brushless motor 16 via the lead wires 40 or the sensor board 80. An example of the switching element 44 is a field effect transistor (FET).

The microcomputer 46 disposed on the control circuit board 36 is connected to rotation detection elements 81, 81 . . . via the lead wires 41, 41 . . . so that rotation detection signals sent by the rotation detection elements 81, 81 . . . disposed on the sensor board 80 can be received. The rotation detection elements 81 detect the positions of the magnetic poles of the rotor 56 and send them as rotation detection signals. The lead wire 41 is a wire used to perform an output from the sensor board 80 to the control circuit board 36. The microcomputer 46 can obtain the rotation state (the rotational angle from the reference position) of the rotor 56 by grasping and summarizing the rotation detection signal indicating the positions of the magnetic poles of the rotor 56 sent from the rotation detection element 81.

Then, depending on the obtained rotation state of the rotor 56 (depending on the states of the received rotation detection signals), the microcomputer 46 outputs driving signals 89, 89 . . . (collectively indicated as one white arrow in FIG. 4) for controlling on/off of the switching elements 44, 44 . . . in the three-phase bridge circuit portion 84 to the corresponding switching elements 44. By switching depending on these driving signals 89, it is possible to flow current through the coils 76 of the stator 58 in sequence, so that the rotor 56 is rotated.

As the control circuit board 36 has at least one of the microcomputer 46 and the switching elements 44, 44 . . . (the three-phase bridge circuit portions 84), the control circuit board 36 is a board controlling the brushless motor 16.

Various types of elements and lead wires on the sensor board 80 are mounted by a reflow method or the like so that the amount of projection from the surface (the rear surface of the sensor board 80) is suppressed (surface mount, SMT: Surface Mount Technology).

The reflow method includes a procedure of printing a predetermined pattern of soldering on the sensor board 80 (or applying an adhesive to component mounting positions by a dispenser), placing various types of elements and lead wires by a chip mounter, heating and melting solder in a reflow furnace, and securing various types of elements and lead wires. This method eliminates the need for boring holes for placing elements and the like in the sensor board 80 and the need for passing the pins of elements and so on through the sensor board 80 and soldering them on the opposite side.

The driving force transfer mechanism 18 includes, sequentially from the rear side, a planetary gear mechanism 90, a spindle 91, an elastic coil-shaped spring 92, a hammer 93, the anvil 94, and a shaft 95, which are concentrically accommodated.

The planetary gear mechanism 90 includes an internal gear 100 having internal teeth, a plurality of planetary gears 102, 102 . . . having external teeth engaging the internal gear 100, and pins 104, which are shafts of the planetary gears 102.

The internal gear 100 is attached unrotatably in the gear case 22.

The planetary gears 102 engage the pinion 69 of the motor shaft 60 of the brushless motor 16 disposed inside the rear part of the gear case 22.

The spindle 91 is a shaft-shaped member that extends in a front-rear direction and has a disc portion 91a in the rear part. The disc portion 91a projects outward (up, down, left, and right) with respect to the other part of the spindle 91 and has a diameter larger than the other part. The rear part of the disc portion 91a is positioned in the front part of the internal gear 100.

A spindle bearing 110 for receiving the spindle 91 is provided between screw hole portions 4 and 4 provided in a gear case 22. The spindle bearing 110 is held in front of the planetary gear mechanism 90 substantially in the middle of the gear case 22.

A plurality of pin holes (equal to the number of the pins 104) corresponding to the front end parts of the pins 104 of the planetary gears 102 are provided in the rear surface of the disc portion 91a of the spindle 91. The pins 104 are provided on the rear side of the disc portion 91a in a state in which the front end part is inserted into the pin hole.

The planetary gears 102 are provided around the pin 104 rotatably about the corresponding pins 104.

A spindle hole 91b is a hole extending forward from the rear surface of the disc portion 91a of the spindle 91. The motor shaft 60 of the brushless motor 16 and an end part (the part not engaging the planetary gears 102) of the pinion 69 are inserted into the spindle hole 91b in a state in which a space is left with respect to the peripheral surface of the spindle hole 91b.

The hammer 93 has a depression 93a depressed cylindrically forward from the rear surface and the front part of the spring 92 is inserted into the depression 93a. A washer 112 is in contact with the front end surface of the spring 92 and a plurality of small balls 114, 114 . . . are provided on the front side of it. The washer 112 and the small balls 114, 114 . . . are provided between the bottom (front end part) of the depression 93a and the front end part of the spring 92.

The rear end part of the spring 92 is in contact with a washer 115 and the washer 115 is in contact with the spindle bearing 110.

Balls 116 and 116 are provided between the hammer 93 and the front part of the spindle 91 for guiding the hammer 93 mainly in the front-rear direction during a strike.

The anvil 94 on the front side of the hammer 93 has extending portions 94a and 94a extending radially in the rear end part.

On the front side of extending portion 94a and 94a, an anvil bearing 120 supports the anvil 94 rotatably about the axis and unmovably in the axis direction. The anvil bearing 120 is held in front of the hammer 93 in the front part of the gear case 22.

A rear hole 94b is provided so as to extend forward from the rear surface of the anvil 94 in the center of the rear part of the anvil 94. The front end part of the spindle 91 is inserted into the rear hole 94b in a state in which a rotary striking force can be transferred.

In addition, in the front part of the anvil 94, a front hole 94c extends backward from the front surface and receives the rear part of the shaft 95 so as to be able to transfer a rotary force. The front hole 94c of the anvil 94 is linked to the rear part of the shaft 95 via a spline structure.

The shaft 95 is a shaft-shaped member extending in the front-rear direction and has a bevel gear portion 95a in its front part.

The front and rear parts of the shaft 95 other than the bevel gear portion 95a in the shaft 95 are surrounded by the shaft bearings 122 and 122 and the shaft 95 is supported rotatably about itself. The shaft bearing 122 is attached to the hammer case 21. A cylindrical spacer 124 is provided between the shaft bearings 122 and 122.

The output shaft 20 is a shaft-shaped member extending in the up-down direction and has a bevel gear portion 20a in its middle part. The bevel gear portion 20a engages the bevel gear portion 95a of the shaft 95.

An upper output bearing 130 is provided around the upper end part of the output shaft 20. A lower output bearing 132 is provided on the lower side of the bevel gear portion 20a of the output shaft 20. The output shaft 20 is rotatably supported by the upper output bearing 130 and the lower output bearing 132 about the output shaft 20.

In addition, a chuck portion 20b is bored at an end part (lower end part) of the output shaft 20. The chuck portion 20b includes a hole extending upward from the lower surface and holds a bit (not shown). In the middle of the chuck portion 20b, chuck balls 134 and 134 corresponding to the small concave portion of the bit are provided in the front and rear parts.

The outside of the chuck portion 20b is covered with a cylindrical sleeve 136. A space opened downward is formed between the outer surface of the lower part of the chuck portion 20b and the inner surface of the lower part of the sleeve 136. A spring 137 and a washer 138 in contact with the lower surface of the spring 137 are provided in the space. The washer 138 is locked by a retaining ring 140 embedded in the outer surface of an end part of a chuck portion 20c so as to be in contact with the inside of the lower surface. The hammer case 21 has an opening 21a opened downward on the outside of the sleeve 136 and a bumper 142 (made of an elastic material) covering the opening 21a is disposed outside and below the opening 21a.

The hammer case 21 and the members (the members in front of the gear case 22, that is, those from the shaft 95 to the output shaft 20) in the front part can be adapted (modularized) and the module can be assembled by disposing the rear part of the hammer case 21 on the outside of the gear case 22 and inserting the rear part of the shaft 95 into the front hole 94c of the anvil 94.

An example of the operation of the angle impact driver 1 described above will be described.

When the user grasps the outside of the housing 2 (the main body housing 17) and pulls the switch lever 23 upward, the upper part of the plunger 51 is inserted into the switch body 50 to turn on the switch 14. Then, power is supplied from the battery 10 to the brushless motor 16 (driving circuit 82), and the rotor 56 rotates under control of the control circuit board 36 and the sensor board 80.

The rotary force of the rotor 56 is reduced by the planetary gears 102, 102 . . . operating while rotating in the internal gear 100 and then transferred to the spindle 91 via pins 104, 104 . . . .

The spindle 91 rotates the anvil 94 and the shaft 95. When a torque equal to or more than a predetermined threshold is applied to the anvil 94, the spindle 91 causes the hammer 93 to swing (strike) forward and backward. During a strike, buffering effects by the spring 92 act on the hammer 93 (and the spindle 91).

The shaft 95 rotates (strikes) the output shaft 20 angled at 90 degrees with respect to the motor shaft 60 via the bevel gear portions 95a and 20a and rotates (strikes) the bit attached to the chuck portion 20b.

The above angle impact driver 1 includes the brushless motor 16 having the motor shaft 60, the switch 14 for energizing the brushless motor 16, the output shaft 20 to which rotation of the brushless motor 16 is transfer, the output shaft 20 being angled with respect to the motor shaft 60, the housing 2 accommodating the brushless motor 16 and the switch 14, and the sensor board 80 detecting rotation of the motor shaft 60. The sensor board 80 is secured to the brushless motor 16.

Accordingly, as it is not necessary to provide a projection or lid projecting externally from the housing 2 to access the brush when replacing the brush, the housing 2 and the angle impact driver 1 is made compact, thereby improving the operability by eliminating unnecessary projections.

Since the brush does not need to be replaced, the maintainability can be improved, the unavailable time until the brush that has reached its service life is replaced with a new brush can be avoided, and preparation of a new brush becomes unnecessary.

As compared with a motor that requires a brush, the motor shaft 60 of the brushless motor 16 can easily rotate at higher speed (the number of revolutions per predetermined time can be increased), thereby achieving stronger output in the output shaft 20.

In addition, as the sensor board 80 is secured to the rear side of the second insulating member 74 of the brushless motor 16, a rotation detection device can be disposed in a position adjacent to the motor shaft 60 and the rotation state of the motor shaft 60 can be detected reliably in an efficient structure.

Alternatively, the angle impact driver 1 includes the brushless motor 16 having the motor shaft 60, the switch 14 for energizing the brushless motor 16, the output shaft 20 to which rotation of the brushless motor 16 is transferred, the output shaft 20 being angled with respect to the motor shaft 60, the housing 2 accommodating the brushless motor 16 and the switch 14, and the battery 10 secured to the housing 2. The switch 14 is disposed between the battery 10 and the brushless motor 16.

Accordingly, the power lead wires 38, 52 . . . can be shortened, wiring can be routed easily, and a wire is not easily broken even if a load such as an impact or vibration is applied.

In addition, the angle impact driver 1 includes the brushless motor 16 having the motor shaft 60, the switch 14 for energizing the brushless motor 16, the output shaft 20 to which rotation of the brushless motor 16 is transferred, the output shaft 20 being angled with respect to the motor shaft 60, the housing 2 accommodating the brushless motor 16 and the switch 14, and the control circuit board 36 accommodated in the housing 2. The switch 14 is disposed between the control circuit board 36 and the brushless motor 16.

Accordingly, wiring between the switch 14 and the control circuit board 36 or between the switch 14 and the brushless motor 16 can be easily performed using the power lead wires 38, 52 . . . or lead wires 40, 41 . . . .

As the control circuit board 36 is away from the brushless motor 16 generating vibrations or heat, the possibility of malfunction of the control circuit board 36 due to effects of vibrations and heat on the control circuit board 36 can be reduced. Therefore, the operation of the brushless motor 16 is ensured. In addition, as the control circuit board 36 generates heat (the switching elements 44 and the microcomputer 46) during operation, the heat resistance is improved by distributing heat sources.

Alternatively, the angle impact driver 1 includes the brushless motor 16 including the rotor 56 having the motor shaft 60 and the stator 58, the fan 68 secured to the motor shaft 60, the switch 14 for energizing the brushless motor 16, the output shaft 20 to which rotation of the brushless motor 16 is transferred, the output shaft 20 being angled with respect to the motor shaft 60, and the housing 2 accommodating the brushless motor 16 and the switch 14. The stator 58 is disposed between the fan 68 and the switch 14.

Accordingly, an air flow generated by the fan 68 easily passes through the stator 58, thereby improving the cooling efficiency of the brushless motor 16. In addition, as the operation unit of the switch 14 is away from the fan 68, the intake port can be easily disposed in a position hard to cover with a hand, thereby contributing to the improvement of the cooling efficiency of the stator 58. In addition, as the fan 68, the switch 14, and the stator 58 are arranged in a single straight line, the diameter of the housing 2 can be made relatively small.

In addition, the angle impact driver 1 includes the brushless motor 16 including the rotor 56 having the motor shaft 60 and the stator 58, the fan 68 secured to the motor shaft 60, the switch 14 for energizing the brushless motor 16, the output shaft 20 to which rotation of the brushless motor 16 is transferred, and the housing 2 accommodating the brushless motor 16 and the switch 14. The switch 14, the brushless motor 16, and the output shaft 20 are disposed in a single straight line.

Accordingly, the diameter of the housing 2 is made relatively small and the angle impact driver 1 can be made more compact.

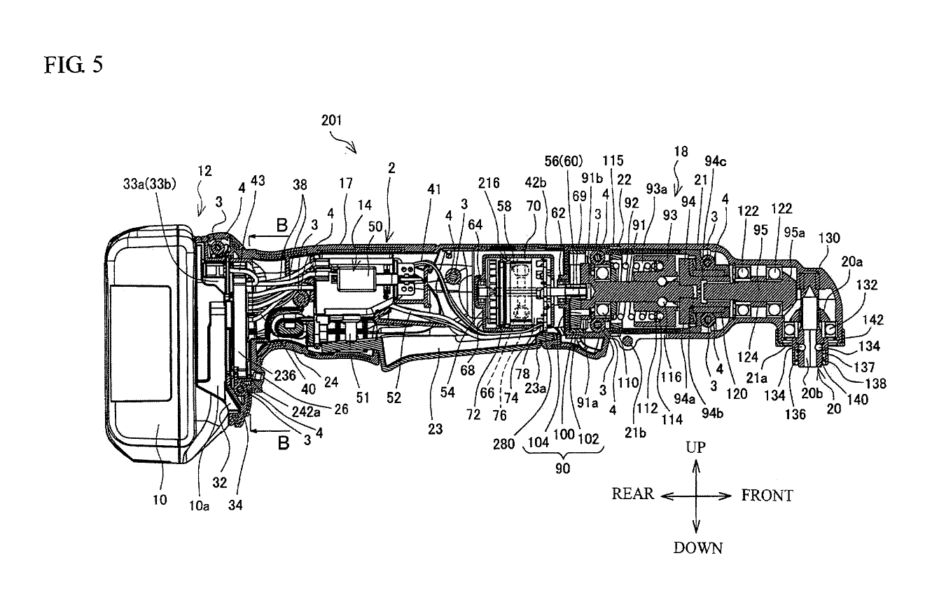

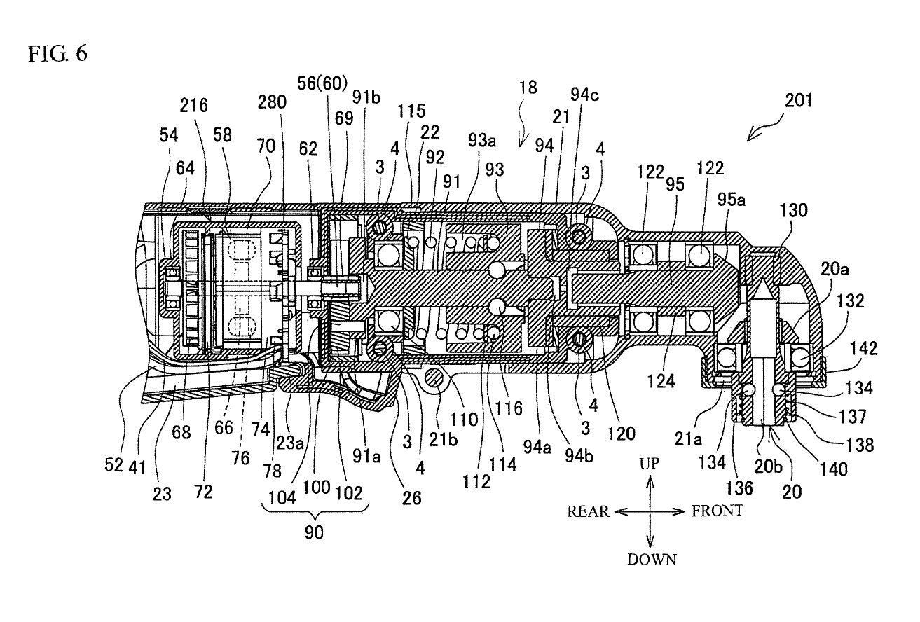

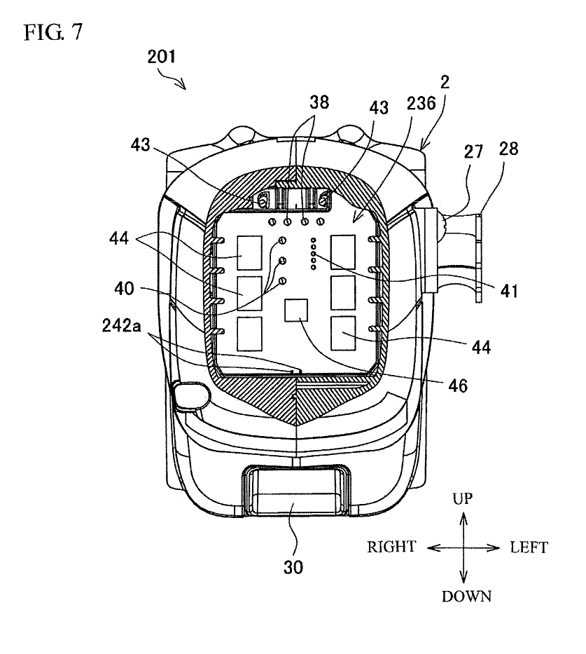

FIG. 5 is a diagram equivalent to FIG. 1 of an angle impact driver 201 according to a second embodiment, FIG. 6 is a diagram of the second embodiment equivalent to FIG. 2, and FIG. 7 is a diagram of the second embodiment equivalent to FIG. 3.

The angle impact driver 201 in the second embodiment is configured as in the first embodiment except the arrangement of the brushless motor, the light, the control circuit board, the fan, the sensor board, the intake port, the exhaust port, and the lead wires. The same members as in the first embodiment are given the same reference numerals and descriptions are omitted as appropriate.

The brushless motor 216 in the second embodiment is oriented opposite to the first embodiment.

That is, the second insulating member 74 is disposed in the front part and the first insulating member 72 is disposed in the rear part.

A sensor board 280 is secured in front of the second insulating member 74. The sensor board 280 is configured like the sensor board 80 except that the front and rear are opposite and the up and down are opposite. That is, the connection portions with the lead wires 40 and 41 and the power lead wire 52 are disposed in the lower rear. The rotation detection elements 81 are disposed in the lower part on the rear surface.

The fan 68 is disposed at the rear of the first insulating member 72.

The intake port is formed in the part of the housing 2 outside the front part of the brushless motor 216 and the exhaust port is formed in the part of the housing 2 outside the rear side (the forward-reverse inverting switch 24) of the switch 14.

The light 26 is disposed in the lower part on the front side of the control circuit board 236 and directly connected to the control circuit board 236 by terminals 242a and 242a. The control circuit board 236 is configured similar to the control circuit board 36 except the wiring concerning the light 26.

Accordingly, in the angle impact driver 201, the switch 14 is disposed between the battery 10 and the brushless motor 216. In addition, the switch 14 is disposed between the control circuit board 236 and the brushless motor 216. The stator 58 is disposed between the sensor board 280 and the switch 14. The switch 14, the brushless motor 216, and the output shaft 20 are disposed in a single straight line.

In the angle impact driver 201 according to the second embodiment, as the sensor board 280 is secured to the brushless motor 216, the rotation state of the motor shaft 60 can be detected reliably in an efficient structure. Further, a more compact and easy-to-grasp structure is achieved, and time and effort of maintenance are reduced, thereby reducing an unavailable period.

As the switch 14 is disposed between the battery 10 and the brushless motor 216, the power lead wires 38, 52 . . . can be shortened, wiring can be routed easily, and a wire is not easily broken even if a load is applied.

In addition, as the switch 14 is disposed between the control circuit board 236 and the brushless motor 216, wiring between the switch 14 and the control circuit board 236 or between the switch 14 and the brushless motor 216 can be easily performed using the power lead wires 38, 52 . . . or lead wires 40, 41 . . . . Further, the operation of the brushless motor 216 can be made more reliable by further improving heat resistance.

The angle impact driver 201 includes the brushless motor 216 including the rotor 56 and the stator 58, the rotor 56 having the motor shaft 60, the motor shaft 60 secured to the rotor 56, the fan 68 secured to the motor shaft 60, the switch 14 for energizing the brushless motor 216, the output shaft 20 to which rotation of the brushless motor 216 is transferred, the output shaft 20 being angled with respect to the motor shaft 60, the housing 2 accommodating the brushless motor 216 and the switch 14, and the sensor board 280 detecting rotation of the rotor 56. The stator 58 is disposed between the sensor board 280 and the switch 14. Accordingly, the fan 68 can be placed on the opposite side of the sensor board 280 across the stator 58, the intake port is provided on the front side of the stator 58, and the exhaust port can be provided away from the intake port. Therefore, intake air is not easily mixed with exhaust air, and intake air and exhaust air are not easily blocked by a hand, thereby making an air flow smoother.

The switch 14, the brushless motor 216, and the output shaft 20 are disposed in a single straight line to achieve compactness.

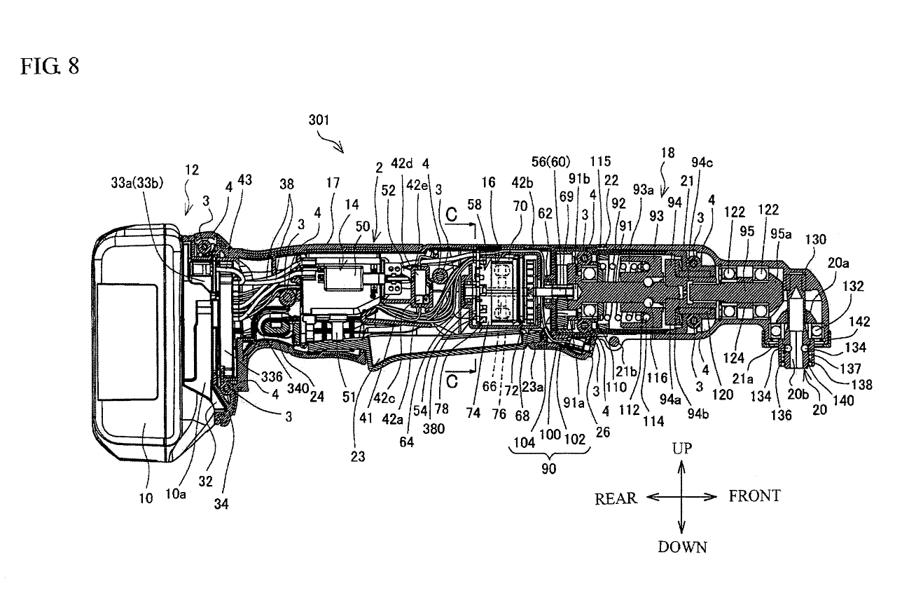

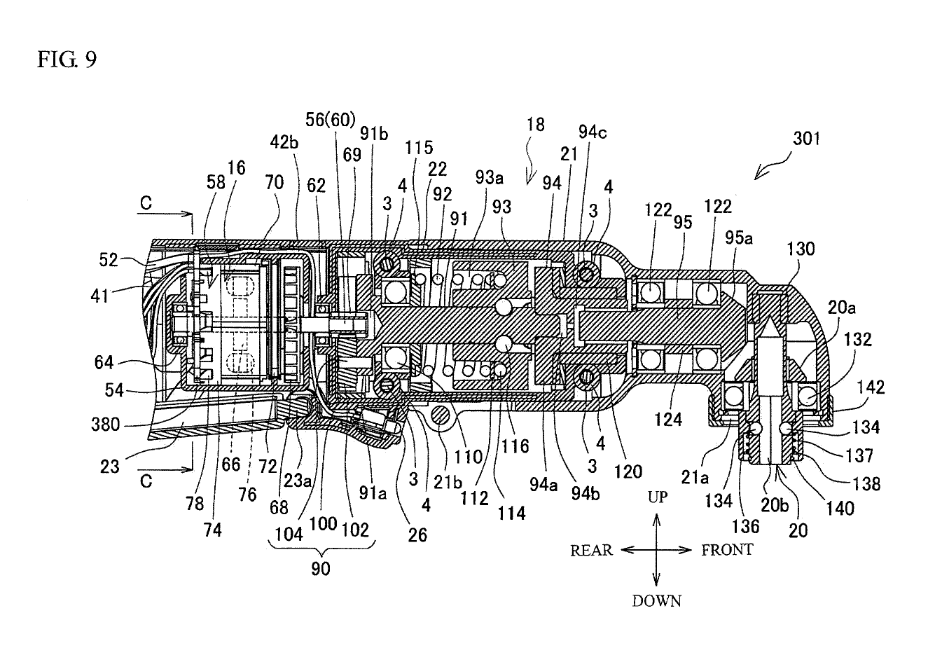

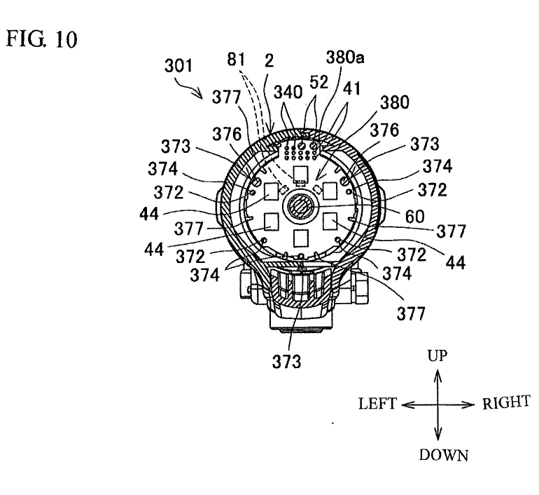

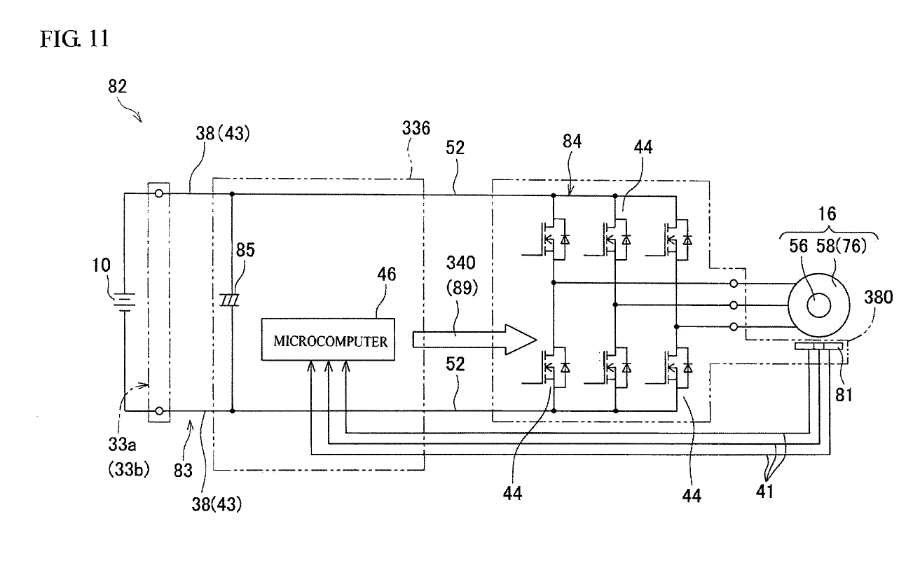

FIG. 8 is a diagram equivalent to FIG. 1 of an angle impact driver 301 according to a third embodiment. FIG. 9 is a diagram of the third embodiment equivalent to FIG. 2. FIG. 10 is a diagram of the third embodiment equivalent to FIG. 3. FIG. 11 is a diagram of the third embodiment equivalent to FIG. 4.

The angle impact driver 301 in the third embodiment is configured as in the first embodiment except the structures of the control circuit board and the sensor board and the types of signals flowing through a part of lead wires. The same members as in the first embodiment are given the same reference numerals and descriptions are omitted as appropriate.

A sensor board 380 according to the third embodiment has the rotation detection elements 81, 81 . . . on the front side and has the switching elements 44, 44 . . . (the three-phase bridge circuit portion 84) on the rear side. A control circuit board 336 does not include the switching elements 44, 44 . . . (the three-phase bridge circuit portion 84) and includes the microcomputer 46 controlling them. The switching elements 44, 44 . . . are disposed on a circle so as to be located on the six vertexes of a hexagon.

On the periphery of a sensor board 380, small holes 372, 372 . . . and small slits 373, 373 . . . are provided. On the second insulating member 74, small projection 374, 374 . . . projecting from a part of the rear surface other than the concave portion 78, 78 . . . are provided so as to correspond to small holes 372, 372 . . . and the small slit 373 below. The sensor board 380 is secured with the corresponding small projections 374 inserted into the small holes 372 and the small slits 373 below. In the part of the rear part of the second insulating member 74 that corresponds to the left and right small slits 373 and 373, there are a screw hole (not shown) into which a screw 376 is inserted to secure the sensor board 380 to the rear side of the second insulating member 74. In addition, on the rear surface of the second insulating member 74, coil connection portions 377, 377 . . . corresponding to the coils 76, 76 . . . are formed and the sensor board 380 and the coils 76 are electrically connected in the coil connection portions 377. The sensor board 80 in the first embodiment is secured in the same way as the sensor board 380 in the third embodiment.

Six lead wires 340 installed in place of the (three) lead wires 40 between the control circuit board 336 and the sensor board 380 transfer the driving signals 89, 89 . . . (indicated as one white arrow in FIG. 11) for controlling the on/off of the switching elements 44, 44 . . . in the three-phase bridge circuit portion 84 in place of the output signals from the switching elements 44, 44 . . . . The power lead wire 52 and the lead wires 340 and 41 are connected in the upper part on the rear surface. The upper part (lead wire connection portion 380a) on the rear surface of the sensor board 380 projects upward from the disc portion located below.

Accordingly, in the angle impact driver 301, the sensor board 380 is secured to the brushless motor 16. In addition, the switch 14 is disposed between the battery 10 and the brushless motor 16. In addition, the switch 14 is disposed between the control circuit board 336 and the brushless motor 16. The stator 58 is disposed between the fan 68 and the switch 14. In addition, the switch 14 is provided between the control circuit board 336 and the plurality of switching elements 44, 44 . . . . The switch 14, the brushless motor 16, and the output shaft 20 are disposed in a single straight line.

In the angle impact driver 301 according to the third embodiment, since the sensor board 380 is secured to the brushless motor 16, the rotation state of the motor shaft 60 can be detected reliably in an efficient structure. Further, a more compact and easy-to-grasp structure is achieved, and time and effort of maintenance are reduced, thereby reducing an unavailable period.

As the switch 14 is disposed between the battery 10 and the brushless motor 16, the power lead wires 38, 52 . . . can be shortened, wiring can be routed easily, and a wire is not easily broken even if a load is applied.

In addition, as the switch 14 is disposed between the control circuit board 336 and the brushless motor 16, wiring between the switch 14 and the control circuit board 336 or between the switch 14 and the brushless motor 16 can be performed easily using the power lead wires 38, 52 . . . or the lead wires 340, 41 . . . . Further, the operation of a brushless motor 16 can be made more reliable by further improving heat resistance.

The stator 58 is disposed between the fan 68 and the switch 14. Therefore, the cooling efficiency of the brushless motor 16 is improved and the diameter of the housing 2 can be made relatively small.

As the switch 14 is provided between the control circuit board 336 and the switching elements 44, 44 . . . , the switching elements 44, 44 . . . heated by driving can be separated from the control circuit board 336. Therefore, occurrence of heat accumulation is reduced, the cooling of the switching elements 44, 44 . . . and a control circuit board 436 is facilitated, thereby ensuring more reliable operation.

In addition, as the switch 14, the brushless motor 16, and the output shaft 20 are disposed in a single straight line, compactness can be achieved.

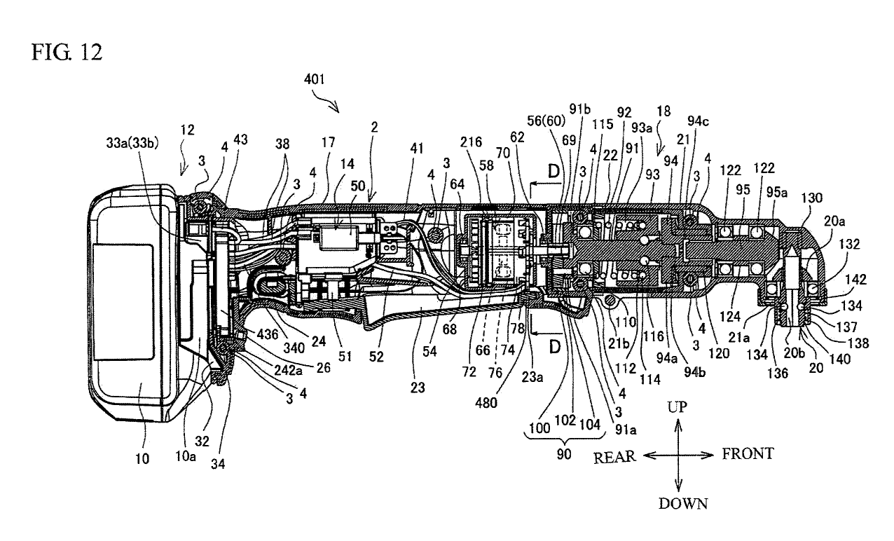

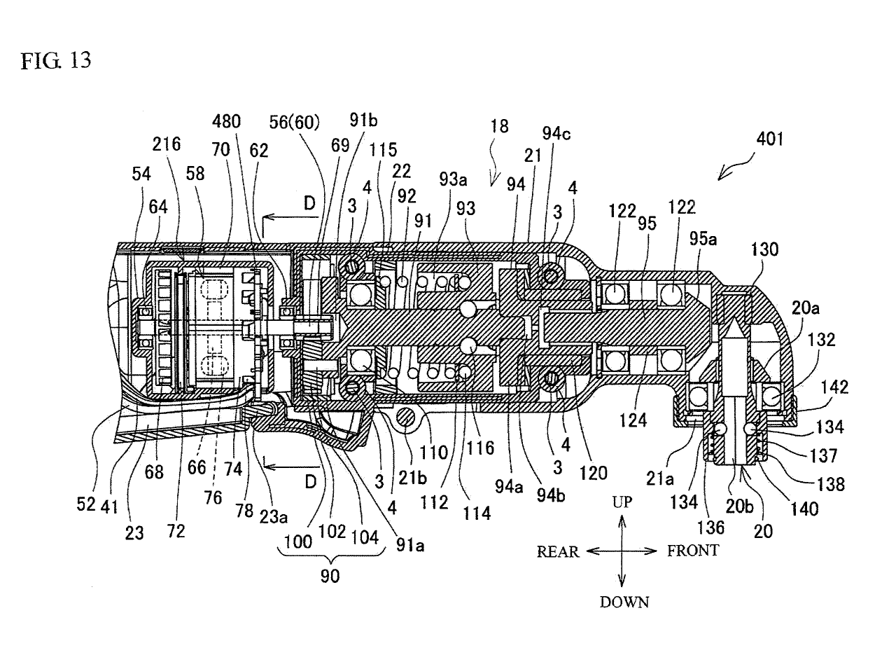

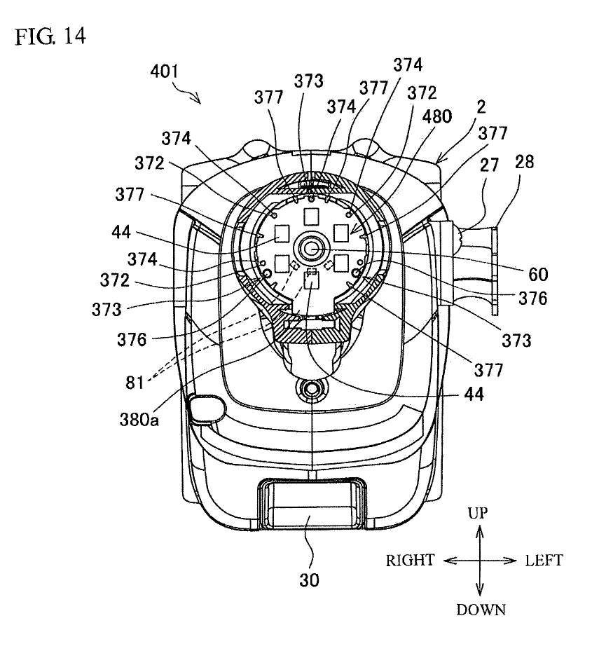

FIG. 12 is a diagram equivalent to FIG. 1 of an angle impact driver 401 according to a fourth embodiment, FIG. 13 is a diagram of the fourth embodiment equivalent to FIG. 2. FIG. 14 is a diagram of the fourth embodiment equivalent to FIG. 3.

The angle impact driver 401 in the fourth embodiment is configured as in the second embodiment except the structures of the control circuit board and the sensor board and the types of signals flowing through a part of lead wires. The same members as in the second embodiment are given the same reference numerals and descriptions are omitted as appropriate.

A sensor board 480 in the fourth embodiment is configured and secured like the sensor board 380 according to the third embodiment except that the sensor board 480 has the rotation detection elements 81, 81 . . . on the rear side and has the switching elements 44, 44 . . . (the three-phase bridge circuit portions 84) on the front side. However, the power lead wires 52 and the lead wires 340 and 41 are connected in the lower part on the rear surface of the sensor board 480 (the lead wire connection portion 380a is disposed in the lower part). The sensor board 280 according to the second embodiment is secured in the same way as the sensor board 480 according to the fourth embodiment.

The control circuit board 436 according to the fourth embodiment is configured like the control circuit board 336 according to the third embodiment except that connection with the light 26 is direct as in the second embodiment. The lead wires 340 installed in place of the (three) lead wires 40 between the control circuit board 436 and the sensor board 480 transfer the driving signals 89, 89 . . . .

The brushless motor 216 is disposed in the angle impact driver 401 as in the second embodiment and, from the front, the pinion 69, the front bearing 62, the sensor board 480, the stator 58, the fan 68, the rear bearing 64 are arranged in sequence.

Accordingly, in the angle impact driver 401, the sensor board 480 is secured to the brushless motor 216. The switch 14 is disposed between the battery 10 and the brushless motor 216. In addition, the switch 14 is disposed between the control circuit board 436 and the brushless motor 216. The stator 58 is disposed between the sensor board 480 and the switch 14. Further, the switch 14 is provided between the control circuit board 436 and the plurality of switching elements 44, 44 . . . . The switch 14, the brushless motor 216, and the output shaft 20 are disposed in a single straight line.

In the angle impact driver 401 according to the fourth embodiment, the sensor board 480 is secured to the brushless motor 216. Therefore, the rotation state of the motor shaft 60 can be detected reliably in an efficient structure. Further, a more compact and easy-to-grasp structure is achieved, and time and effort of maintenance are reduced, thereby reducing an unavailable period.

The switch 14 is disposed between the battery 10 and the brushless motor 216, the power lead wires 38, 52 . . . can be shortened, wiring can be routed easily, and a wire is not broken easily even if a load is applied.

In addition, as the switch 14 is disposed between the control circuit board 436 and the brushless motor 216, wiring between the switch 14 and the control circuit board 436 or between the switch 14 and the brushless motor 216 can be performed easily using the power lead wires 38, 52 . . . or the lead wires 340, 41 . . . . Further, the operation of a brushless motor 216 can be made more reliable by further improving heat resistance.

As the stator 58 is disposed between the sensor board 480 and the switch 14, the fan 68 can be placed on the opposite side of the sensor board 480 across the stator 58. Therefore, intake air is not easily mixed with exhaust air, and intake air and exhaust air are not easily blocked by a hand, thereby making an air flow smoother.

As the switch 14 is provided between the control circuit board 436 and the switching elements 44, 44 . . . , the switching elements 44, 44 . . . heated by driving can be separated from the control circuit board 436. Therefore, the possibility of heat accumulation is reduced, the cooling of the switching elements 44, 44 . . . and the control circuit board 436 is facilitated, thereby ensuring more reliable operation.

The switch 14, the brushless motor 216, and the output shaft 20 are disposed in a single straight line to achieve compactness.

The invention is not limited to the above embodiments and, for example, the following changes can be made as needed.

The lead wires and elements on the control circuit board or the sensor board may be connected or installed in positions other than the connection positions and installation positions shown above. Each of the connection positions may be divided into a plurality of positions. The arrangement of the lead wires may be changed variously. For example, two power lead wires may be disposed upper and lower positions (one is disposed in an upper position and the other is disposed in a lower position).

Further, the lead wires, the elements, and the coils of the brushless motor can be increased or reduced in number or in type. In particular, the lead wires can be increased or reduced as appropriate depending on the embodied product. Similarly, the number of separations of the housings, the number of planetary gear installed, and the number of magnetic poles of the magnet of the brushless motor may be increased or reduced. In addition, the number, arrangement, material, size, form, type, and the like of various types of members can be changed. For example, the form of the switch of the switch lever can be changed, or the battery can be changed to a rechargeable battery other than a lithium ion battery or to a primary battery.

The sensor board may be secured to the stator using a projection to be inserted into a hole, a screw and a screw hole, a claw and a locking part locking the claw, or combination of them.

The space between the stator and the sensor board may be formed by proving a concave portion on the sensor board side, providing concave portions on both sides, or providing a convex portion on at least one side.

In addition, the invention is applicable to rotary impact tools other than an angle impact driver, other impact tools, other angle tools, or other electric tools.

1-7. (canceled)

8. An angle tool comprising:
a brushless motor having a motor shaft;
a switch for energizing the brushless motor;
an output shaft to which rotation of the brushless motor is transferred, the output shaft being angled with respect to the motor shaft;
a housing accommodating the brushless motor and the switch; and
a control circuit board accommodated in the housing; wherein
the switch is disposed between the control circuit board and the brushless motor.

9. The angle tool according to claim 8, further comprising:
a sensor board detecting rotation of the motor shaft; wherein
the sensor board is secured to the brushless motor.

10. The angle tool according to claim 8, further comprising a battery, wherein
the battery is secured to the housing, and the switch is disposed between the battery and the brushless motor.

11. The angle tool according to claim 8, further comprising:
a rotor having the motor shaft,
a fan secured to the motor shaft,
a sensor board detecting rotation of the rotor, and
a stator; wherein
the brushless motor includes the rotor and the stator, and the stator is disposed between the sensor board and the switch.

12. The angle tool according to claim 8, further comprising:
a rotor having the motor shaft,
a fan secured to the motor shaft, and
a stator, wherein
the brushless motor includes the rotor and the stator, and the stator is disposed between the fan and the switch.

13. The angle tool according to claim 8, further comprising:
a rotor having the motor shaft,
a fan secured to the motor shaft,
a stator, and
a plurality of switching elements electrically connected to the stator, wherein
the brushless motor includes the rotor and the stator, and the switch is provided between the control circuit board and the plurality of switching elements.

14. An electric tool comprising:
a brushless motor including a stator and a rotor;
a motor shaft secured to the rotor;
a fan secured to the motor shaft;
a switch for energizing the brushless motor;
an output shaft to which rotation of the brushless motor is transferred; and
a housing accommodating the brushless motor and the switch,
wherein the switch, the brushless motor, and the output shaft are disposed in a single straight line.
